(19) United States
(12) Patent Application Publication
(10) Pub. No.: US 2021/0276682 A1
(43) Pub. Date: Sep. 9, 2021

(54) SPARE PROPELLER SUPPORT DOCK WITH EMBEDDED PIN STORAGE

(71) Applicant: SOCIALSMOKING.COM LLC, Marlboro, NJ (US)

(72) Inventor: Michael Lee Maddux, Arroyo Grande, CA (US)

(73) Assignee: SOCIALSMOKING.COM LLC, Marlboro, NJ (US)

(21) Appl. No.: 17/161,609

(22) Filed: Jan. 28, 2021

Related U.S. Application Data
(60) Provisional application No. 62/967,355, filed on Jan. 29, 2020.

(51) Int. Cl. B63H 1/14; F16M 13/02

(52) U.S. Cl. CPC B63H 1/14; F16M 13/02

(57) ABSTRACT

A spare propellor dock configured with a base plate having a bottom planar surface and a center hole configured for mating to a support shaft. The base plate has at least two mounting holes disposed about the base plate allowing mounting of the dock to a planar surface. A support shaft sized to fit through a propellor's hub is coupled to the center hole of the base plate and a top portion with threads for mating to a nut. The shaft and/or base plate has at least one shear pin housing hole, wherein the dock provides both a support mechanism for a propellor and stores a shear pin.

### CROSS-REFERENCE TO RELATED APPLICATION(S)

This application claims the benefit of U.S. Provisional Patent Application No. 62/967,355 filed Jan. 29, 2020, titled “Spare Propeller Dock Support,” the contents of which are hereby incorporated by reference in its entirety.

### FIELD

This invention relates to spare propeller storage. More particularly, it relates to storing a propeller pin within the spare propeller storage assembly.

### BACKGROUND

Water vessels, particularly, sports fishing boats such as in bass boats and the sorts often use a small electric thrust motor (e.g., trolling motor) that goes on the front of the boat to more easily navigate inshore areas. Because of the close proximity to shallows, the trolling motor's propeller (e.g., prop) may become damaged, requiring a replacement prop to be installed. Storage of the replacement prop is typically facilitated through the use of a prop “dock,” mounted in a storage locker of the boat. However, prop docks are typically large and since the boat is in the water, it is not uncommon while attaching the replacement prop, that parts or pieces critical to the prop attachment to fall into the water. As can be imagined, the loss of a part without a spare can be catastrophic.

Accordingly, an elegant approach is devised below for addressing this deficiency in the art.

### SUMMARY

The following presents a simplified summary in order to provide a basic understanding of some aspects of the claimed subject matter. This summary is not an extensive overview and is not intended to identify key/critical elements or to delineate the scope of the claimed subject matter. Its purpose is to present some concepts in a simplified form as a prelude to the more detailed description that is presented later.

In one aspect of the disclosed embodiments, a spare propellor dock is provided, comprising: a base plate having a bottom planar surface and a center hole configured for mating to a support shaft; at least two mounting holes disposed about the base plate allowing mounting of the dock to a planar surface; a support shaft sized to fit through a propellor's hub, a bottom portion being coupled to the center hole of the base plate, a top portion having threads for mating to a nut; and at least one shear pin housing hole disposed in at least one of a horizontally oriented hole in the shaft and a vertically oriented hole in the base, wherein the dock provides both a support mechanism for a propellor and stores a shear pin.

In another aspect of the disclosed embodiments, the above dock is provided, wherein the shaft is integrally mated to the base plate; and/or further comprising a nut and a washer disposed below the nut; and/or wherein the base plate is triangularly shaped with rounded edges and concave sides; and/or wherein the shaft is of two different diameters, the bottom portion having a greater diameter than the top portion; and/or further comprising a square extension rising from a top of the bottom plate, the extension wider than the bottom portion of the shaft and preventing rotation of a mounted propellor; and/or wherein the at least one shear pin housing holes is vertically disposed in the extension; and/or further comprising a round extension rising from a top of the bottom plate, the extension wider than the bottom portion of the shaft; and/or wherein the extension is at least ½ inch in thickness; and/or wherein the base plate is at least ½ inch in thickness and contains the at least one shear pin housing holes vertically disposed in the base plate; and/or further comprising socket head screw, wherein a top of the shaft contains inner threads for mating to the socket head screw.

In yet another aspect of the disclosed embodiments, a spare propellor dock is provided, comprising: a base plate having a bottom planar surface and a center hole configured for mating to a support shaft; at least two mounting holes disposed about the base plate allowing mounting of the dock to a planar surface; a bolt sized to fit through a propellor's hub, a bottom portion being coupled to threads in the center hole of the base plate; and at least one shear pin housing hole disposed in at least one of a horizontally oriented hole in the bolt and a vertically oriented hole in the base, wherein the dock provides both a support mechanism for a propellor and stores a shear pin.

In yet another aspect of the disclosed embodiments, a method for securing a propellor to a propellor dock is provided, comprising: forming a base plate having a bottom planar surface having a center hole in the base plate for mating to a support shaft; attaching a support shaft sized to fit through a propellor's hub to the center hole of the base plate, a top portion of the shaft having threads for mating to a nut and a bottom portion of the shaft having at least one shear pin housing hole containing a shear pin; mounting the propellor dock to a planar surface by screwing through mounting holes disposed about base plate; fitting a propellor over the support shaft; placing a washer over the top of the shaft; placing a nut over the top of the shaft; and tightening the nut to secure the propellor to the dock.

### BRIEF DESCRIPTION OF THE DRAWINGS

FIG. 1 is an image of an exemplary prop dock.

FIG. 2 is an image of an exemplary prop dock mounted to the underside of a storage lid.

FIG. 3 is an image of a spare prop mounted to an exemplary prop dock.

FIGS. 4A-E are illustrations showing various views of an exemplary mounting plate.

FIGS. 5A-C are top, side and perspective view drawings showing an exemplary mounting shaft for the mounting plate.

FIGS. 6A-B are two perspective illustrations of one embodiment of an exemplary prop dock with an alternative mounting plate and shaft configuration.

FIGS. 7A-B are two perspective illustrations of another embodiment of an exemplary prop dock with an alternative mounting plate and shaft configuration.

FIGS. 8A-B are two perspective illustrations of another embodiment of an exemplary prop dock with an alternative mounting plate and shaft configuration.

FIGS. 9A-B are two perspective illustrations of another embodiment of an exemplary prop dock with an alternative mounting plate and shaft configuration.

FIGS. 10A-B are two perspective illustrations of another embodiment of an exemplary prop dock with an alternative mounting plate and shaft configuration.

FIGS. 11A-B are two perspective illustrations of another embodiment of an exemplary prop dock with an alternative mounting plate and shaft configuration.

FIGS. 12A-B are two perspective illustrations of another embodiment of an exemplary prop dock with an alternative mounting plate and shaft configuration.

### DETAILED DESCRIPTION

The disclosed embodiments are designs of prop docks with built-in accommodations for spare hardware storage. A commonly lost hardware is the propeller shear pin. As a loose item (in a storage locker), the shear pin can be easily misplaced or difficult to find under other stored items. The exemplary prop docks are designed to smoothly “fit” the needed shear pin within the prop dock's support structure, suitable for immediate use when the spare prop is removed from the prop dock.

In various embodiments, the exemplary prop dock is designed to be able to fit more than one type of trolling motor prop. The design is also more compact that other prop docks, thus providing more storage room in the storage area or storage locker. The design can be made from multiple materials, if so desired. In commercial embodiments, it can also be manufactured from a 2-piece billet aircraft grade aluminum with an anodized coating. Further, the presence of the shear pin in the prop dock structure helps to index the prop to prevent rotation of the prop while stored. For example, if the exemplary prop dock is mounted on a locker's lid, when the lid is opened (or closed) it is possible (in a non-indexed system) to have the prop rotate while being stored. This can cause rope or other items to snag on the prop and the prop can be damaged when the lid is opened.

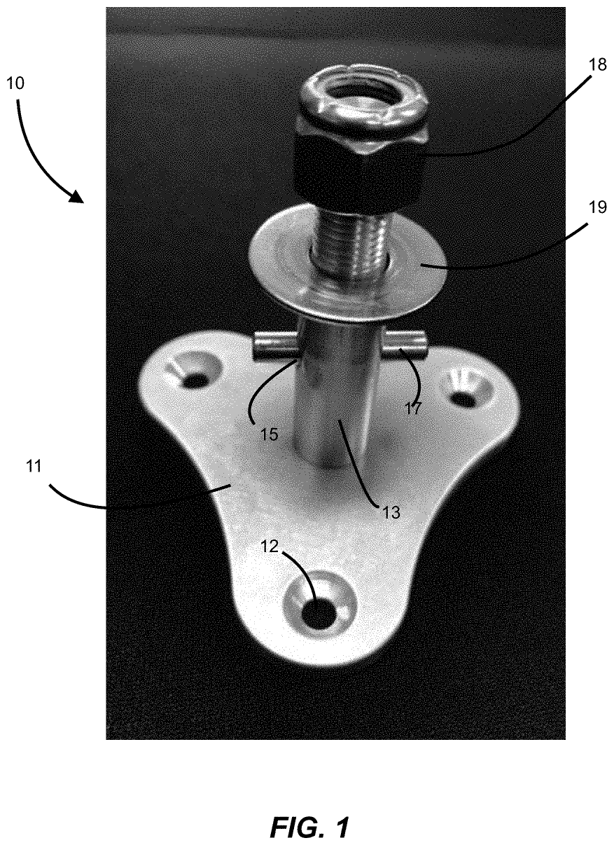

FIG. 1 is an illustration of an exemplary prop dock 10. Base 11 is connected to a prop-supporting shaft 13 having a hole 15 sized for fitment of a removable shear pin 17. The shaft 13 is threaded to accommodate a nut 18. Washer 19 is provided to help the nut 18 secure a prop (not shown) when placed over the shaft 13. The shaft 13 may be of a single diameter or multiple diameters, but is sized to fit through the hub of a propellor. Base 11 is shown here with 3 mounting holes 12, but it is understood that more or less holes may be used. The base 11 is secured via screws, bolts, etc. through the mounting holes 12 into a storage locker or other surface.

In operation, a propellor (not shown here, typically but not necessarily of the trolling type) is placed over the exposed shaft 13 and may or may not entirely “sit” over the stored shear pin 17 (noting that different propellers may have larger-than-shaft-size hub diameters). Notwithstanding the fitting of the propellor over the entire shaft 13, washer 19 or an equivalent is placed over the end of propellor and nut 18 is tightened thereupon. Upon need of the propellor, it is removed from the shaft 13 (upon removal of the nut 18 and washer 19), and shear pin 17 can be easily slid out from the hole 15). In some embodiments, there may be several shear pins in several holes along the shaft 13, thus providing multiple “spare” shear pins.

Typically, the shaft 15 can have a length of 1.5 to 2.5 inches. However, in one commercial embodiment, the shaft 13 was designed with a length of 2.25 inches and the shear pin hole 15 was designed with a diameter of 0.188 inches. Of course, other dimensions and sizes may be used according to design preference.

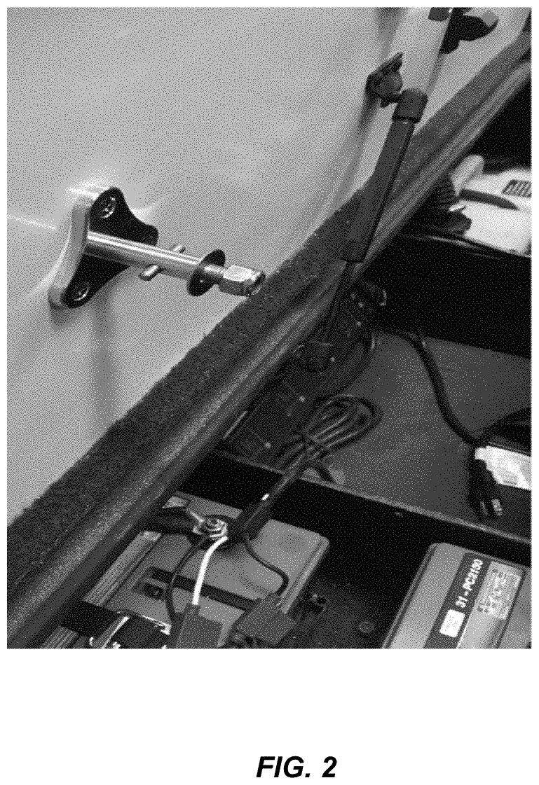

FIG. 2 is an illustration of an exemplary prop dock mounted to the underside of a storage lid that is opened and is understood to be is self-explanatory.

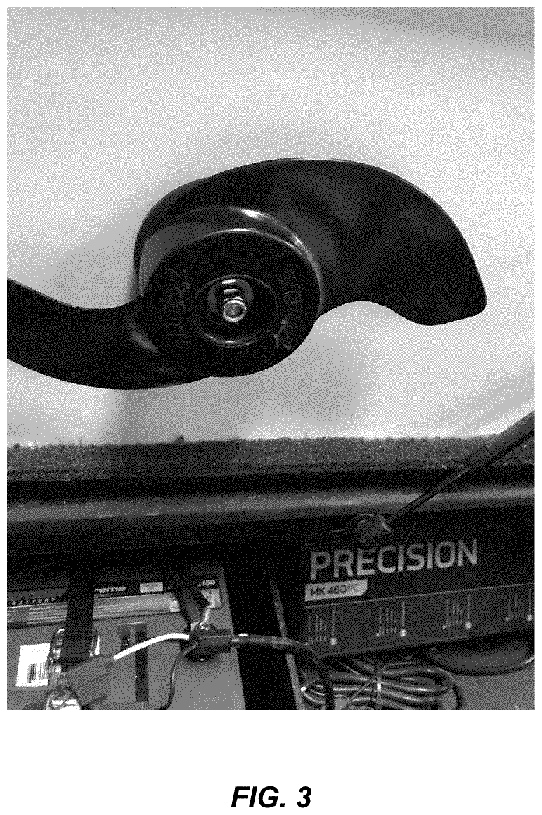

FIG. 3 is an illustration of a spare prop mounted to an exemplary prop dock, showing the nut & washer securing the prop to the dock, and is understood to be is self-explanatory.

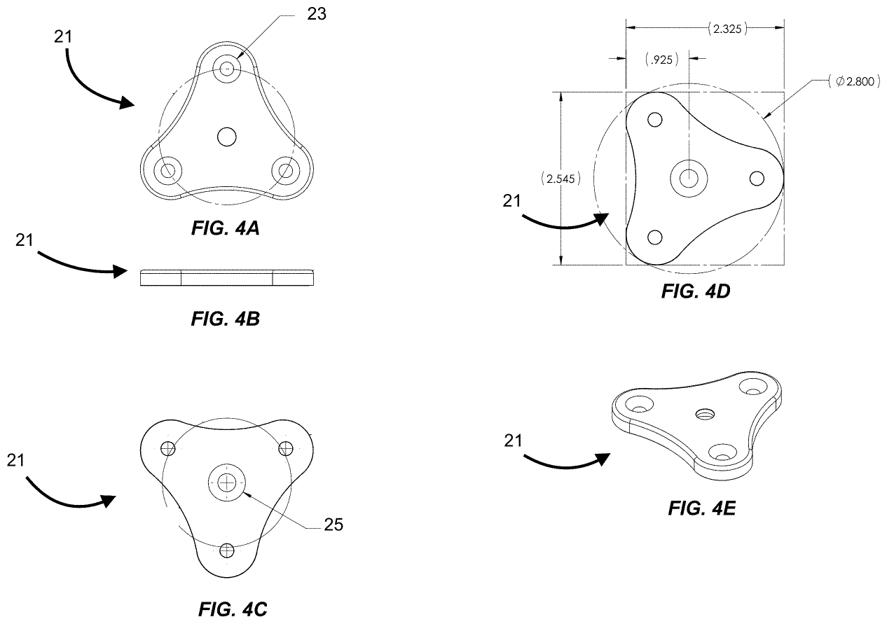

FIGS. 4A-E are illustrations showing top, side, bottom, bottom and perspective views of an exemplary base plate of the exemplary prop support dock. Base plate 21 is shown with a plurality of mounting holes 23 near the periphery and a center hole 25 for mounting a support shaft (not shown). The center hole 25 may be a threaded hole that accommodates a threaded end of the support shaft (not shown), or can other type of securing mechanism. The particular shape and dimension of the base plate 21 are a design choice, therefore, other shapes and sizes may be used without departing from the spirit and scope of this disclosure. The particular location and number of mounting holes 23 can also be a design choice. FIG. 4D contains possible dimensions in “inches” for a commercial embodiment of the base plate 21. Of course, other dimensions may be devised according to design preference.

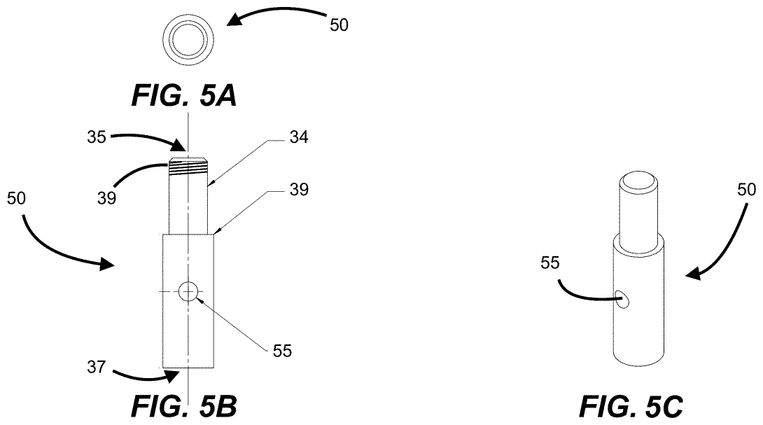

FIGS. 5A-C are illustrations showing top, side and perspective views of an exemplary mounting shaft 50 with shear pin hole 55. The top portion 34 of shaft 50 is threaded 39 for a securing nut (not shown). Shaft 50 is shown here with a dual diameter, the top diameter 35 being smaller than the bottom diameter 37. This configuration allows for a propeller (not shown) that has an outer flange sized to completely “fit” over the top and bottom diameters 35, 37 of the shaft 50 but an inner flange that rests on an edge 39 of the bottom diameter 35 of the shaft 50. Accordingly, in some embodiments the length of shaft 50 and the placement of edge 39 is purposely determined to allow for such propellers to easily and conveniently fit onto the shaft 50. The bottom portion of the shaft 50 may be threaded to allow it to be secured to threads in the base of FIGS. 4A-D. Or, it may be welded, or affixed through other means.

Hole 55 is sized to accommodate the storage of a shear pin (not shown). The size of hole 55 is designed to allow the shear pin (not shown) to slide into and out of the hole 55 without much effort. The shear pin size may be matched to the propellor size or type. Thus, shaft 50, edge 37 and hole 55 may, if so desired, all be designed with dimensions that match fitment for a particular shear pin, propellor type and size. Of course, a generically sized shaft may be used, given that the propellor is ultimately secured via a nut tightened on the top portion 34.

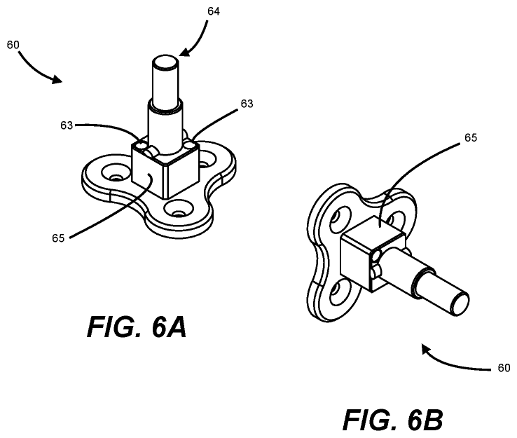

FIGS. 6A-B contains 2 views of another embodiment of an exemplary prop dock 60 with an alternative shaft configuration. Specifically, this embodiment has a similar mounting base as seen in FIG. 1, but has a square base block 65 with the actual indexing bar machined into the part to keep a prop from rotating. It also has a set of 2 holes 63 vertically drilled into opposite sides of the square base to hold 2 shear pins in the base. As can be understood, additional holes may also be drilled or provided on the remaining 2 corners of the base block 65, if so desired. Thus, with 4 base holes, storage of up to 4 shear pins or pins can be provided. If a shear pin hole is also provided in the bottom of the shaft 64, then this embodiment can store up to 5 pins. This design is illustrative of the ability to store pins or other similar items in a reconfigured bottom portion of the shaft 64.

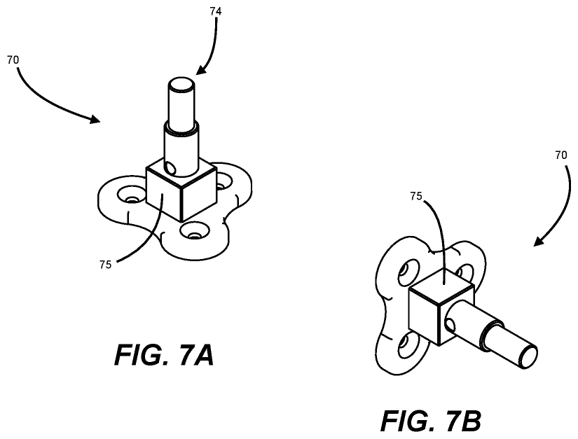

FIGS. 7A-B contains 2 views of another embodiment of an exemplary prop dock 70 with an alternative shaft configuration. This embodiment is similar to the embodiment of FIG. 6, however, no additional vertical drilled holes are in the base block 75. Thus, this design provides storage for 1 shear pin in the shaft 74 itself.

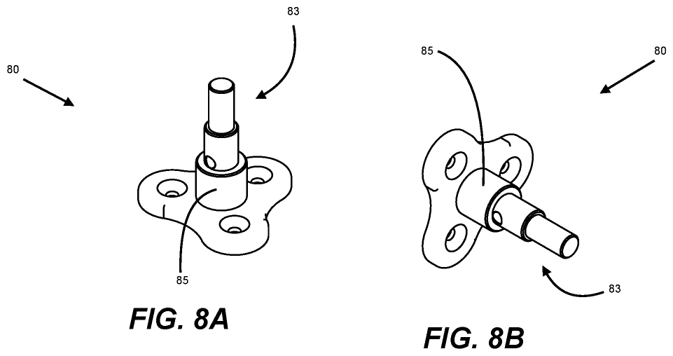

FIGS. 8A-B contains 2 views of another embodiment of an exemplary prop dock 80 with an alternative shaft configuration. This design has a larger diameter bottom portion 85 of the shaft 83. This slightly more robust diameter helps resist higher side directional loads.

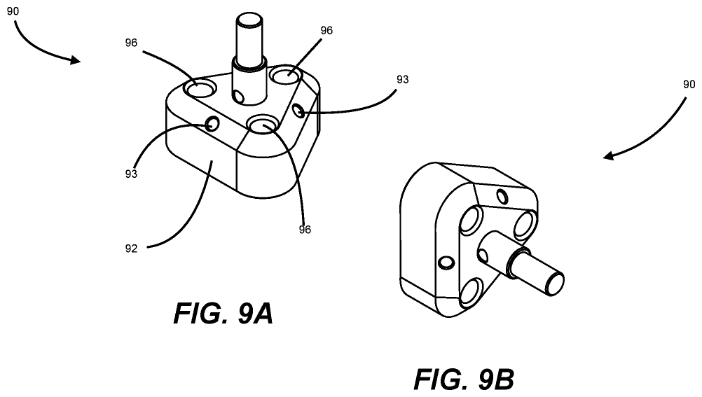

FIGS. 9A-B contains 2 views of another embodiment of an exemplary prop dock 90 with an alternative base configuration. This design has a triangular base 92 that is thick enough to include 3 shear pins or shear pin holes 93 in corners of the base 92 itself. Typically, such a design will have a base that is greater than ½ inch in thickness. The holes 96 for mounting can be pocketed countersink holes (e.g.) below flush.

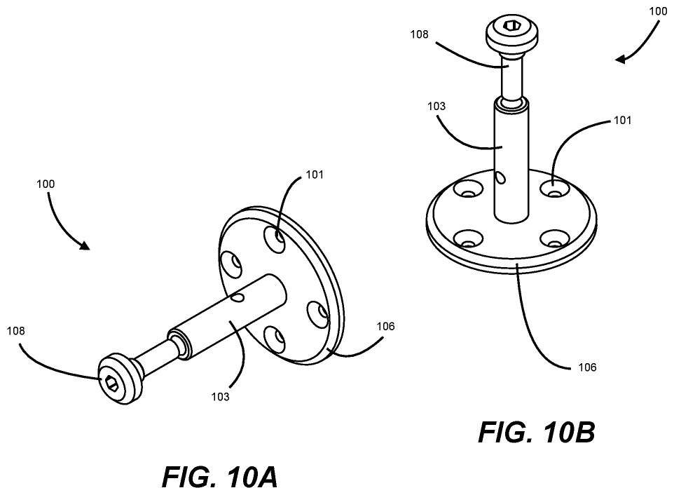

FIGS. 10A-B contains 2 views of another embodiment of an exemplary prop dock 100 with an alternative shaft and base configuration. This design model configures the same shaft design of FIG. 1, but the prop is held on with a stainless socket head screw 108 that screws into the shaft 103, rather than with nut. The top of the shaft 103 would have interior threads (not shown) and an outer bore diameter to accommodate the prop itself, but would require an additional hardware for securing and indexing. The base 106 is shown as a circular design with four mounting holes 101. Of course, more or less mounting holes may be used.

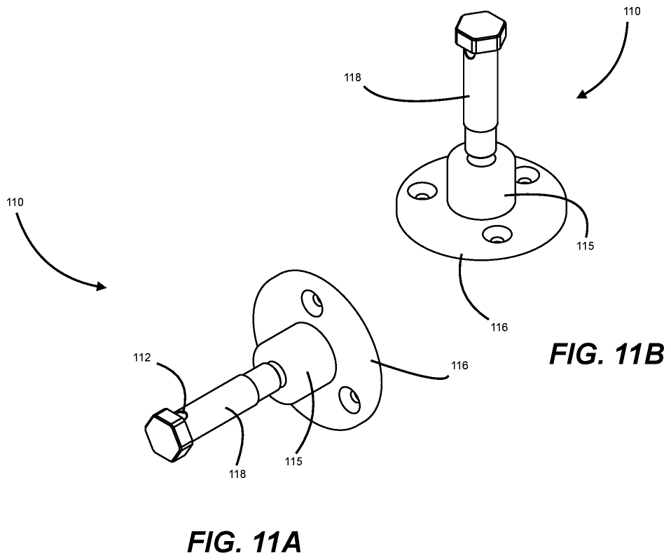

FIGS. 11A-B contains 2 views of another embodiment of an exemplary prop dock 110 with an alternative shaft and base configuration. This design contemplates that the shaft is replaced with a bolt 118 connecting to threaded section 115 above base 116. It would have the shear pin cross section hole 112 just under the head of the bolt and would have to screw the prop into the base 116 by rotating the prop entirely with the shear pin inside the prop's hub.

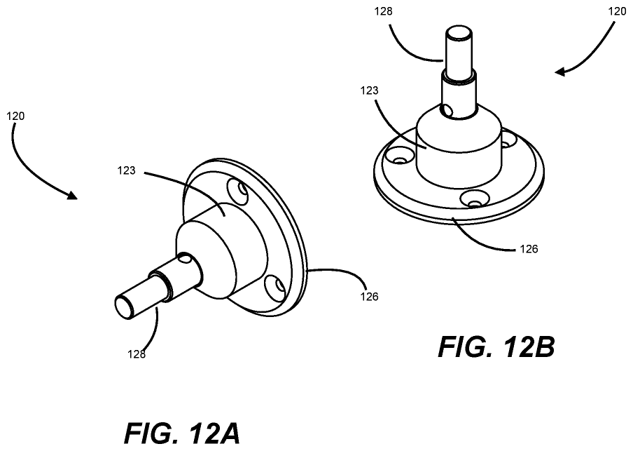

FIGS. 12A-B contains 2 views of another embodiment of an exemplary prop dock 120 with an alternative shaft and base configuration. This design illustrates a wider heavier base portion 123 below the mounting shaft 128 that would prove beneficial for cross sectional load. Typically, the base portion 123 will be greater than ½ inch in thickness. It could have a tapering base with a chamfered edge on it. The base 126 is shown having a circular configuration but may be of any shape.

The foregoing is illustrative only and is not intended to be in any way limiting. Reference is made to the accompanying drawings, which form a part hereof. In the drawings, similar symbols typically identify similar components, unless context dictates otherwise.

While various aspects and embodiments have been disclosed herein, other aspects and embodiments will be apparent to those skilled in the art. The various aspects and embodiments disclosed herein are for purposes of illustration and are not intended to be limiting, with the true scope being indicated by the following claims.

What is claimed is:

1. A spare propellor dock, comprising:
a base plate having a bottom planar surface and a center hole configured for mating to a support shaft;
at least two mounting holes disposed about the base plate allowing mounting of the dock to a planar surface;
a support shaft sized to fit through a propellor's hub, a bottom portion being coupled to the center hole of the base plate, a top portion having threads for mating to a nut; and
at least one shear pin housing hole disposed in at least one of a horizontally oriented hole in the shaft and a vertically oriented hole in the base,
wherein the dock provides both a support mechanism for a propellor and stores a shear pin.

2. The dock of claim 1, wherein the shaft is integrally mated to the base plate.

3. The dock of claim 1, further comprising a nut and a washer disposed below the nut.

4. The dock of claim 1, wherein the base plate is triangularly shaped with rounded edges and concave sides.

5. The dock of claim 1, wherein the shaft is of two different diameters, the bottom portion having a greater diameter than the top portion.

6. The dock of claim 1, further comprising a square extension rising from a top of the bottom plate, the extension wider than the bottom portion of the shaft and preventing rotation of a mounted propellor.

7. The dock of claim 6, wherein the at least one shear pin housing holes is vertically disposed in the extension.

8. The dock of claim 1, further comprising a round extension rising from a top of the bottom plate, the extension wider than the bottom portion of the shaft.

9. The dock of claim 8, wherein the extension is at least ½ inch in thickness.

10. The dock of claim 1, wherein the base plate is at least ½ inch in thickness and contains the at least one shear pin housing holes vertically disposed in the base plate.

11. The dock of claim 1, further comprising socket head screw, wherein a top of the shaft contains inner threads for mating to the socket head screw.

12. A spare propellor dock, comprising:
a base plate having a bottom planar surface and a center hole configured for mating to a support shaft;
at least two mounting holes disposed about the base plate allowing mounting of the dock to a planar surface;
a bolt sized to fit through a propellor's hub, a bottom portion being coupled to threads in the center hole of the base plate; and
at least one shear pin housing hole disposed in at least one of a horizontally oriented hole in the bolt and a vertically oriented hole in the base,
wherein the dock provides both a support mechanism for a propellor and stores a shear pin.

13. A method for securing a propellor to a propellor dock, comprising:
forming a base plate having a bottom planar surface having a center hole in the base plate for mating to a support shaft;
attaching a support shaft sized to fit through a propellor's hub to the center hole of the base plate, a top portion of the shaft having threads for mating to a nut and a bottom portion of the shaft having at least one shear pin housing hole containing a shear pin;
mounting the propellor dock to a planar surface by screwing through mounting holes disposed about base plate;
fitting a propellor over the support shaft;
placing a washer over the top of the shaft;
placing a nut over the top of the shaft; and
tightening the nut to secure the propellor to the dock.
